(19) United States
(12) Patent Application Publication
(10) Pub. No.: US 2014/0250482 A1
(43) Pub. Date: Sep. 4, 2014

(54) SYSTEM AND METHOD FOR REMOVING A PAUSE IN A DELAYED REMOTE BROADCAST INTERVIEW

(71) Applicant: Prime Image Delaware, Inc., Chalfont, PA (US)

(72) Inventor: Christopher Scott Gifford, Nipomo, CA (US)

(73) Assignee: Prime Image Delaware, Inc., Chalfont, PA (US)

(21) Appl. No.: 14/194,393

(22) Filed: Feb. 28, 2014

Related U.S. Application Data
(60) Provisional application No. 61/771,714, filed on Mar. 1, 2013.

(51) Int. Cl. H04N 21/238

(52) U.S. Cl. CPC H04N 21/23805
USPC 725/116

(57) ABSTRACT

A system and method to eliminate or shorten the pause produced by an inherent delay in a broadcast signal. The broadcast signal may include a primary feed and a remote feed. A communication delay is associated with transmitting the primary feed to a remote location and is reflected as an awkward pause in the broadcast signal. One or more segments of the primary feed may be adjusted based on the delay. For example, a variable delay may be added to a segment of the primary feed to increase or decrease a time period associated with the segment.

### CROSS-REFERENCE

This application claims priority from U.S. Provisional Application No. 61/771,714 entitled System and Method for Removing a Pause in a Delayed Remote Broadcast Interview, which is incorporated by reference herein in its entirety.

### BACKGROUND

A live news or entertainment program conducting remote interviews may experience an awkward pause caused by the typically 1-2 second round trip communication delay between the studio or primary location and the remote or secondary location. This phenomenon is clearly noticed by viewers when the newsroom anchor or interviewer is speaking to a remote news reporter or interviewee where the responder can take 1-2 seconds before they start to speak. This communication delay can easily approach 3-4 seconds when the remote feed is routed through cell networks or the internet. There are currently no methods available to eliminate the actual communication delay. Therefore, a system and method to eliminate or shorten the awkward pause caused by the communication delay is desirable.

### BRIEF DESCRIPTION OF THE DRAWINGS

FIG. 1 shows a block diagram of a video and audio processing system in accordance with some embodiments.

FIG. 2 shows a schematic diagram illustrating a frame deletion process in accordance with some embodiments.

FIG. 3 shows a schematic diagram illustrating a frame insertion process in accordance with some embodiments.

FIG. 4A shows an example environment for a primary feed and a remote feed with a variable delay on the primary feed in accordance with some embodiments of the disclosure.

FIG. 4B shows an example environment for a primary feed and a remote feed with a variable delay on the remote feed in accordance with some embodiments of the disclosure.

FIG. 4C shows an example environment for a primary feed and a remote feed with a variable delay on both the primary feed and the remote feed in accordance with some embodiments of the disclosure.

FIG. 5 shows a flow diagram of an example method to adjust a primary feed based on a delay between a primary location and a remote location in accordance with some embodiments.

### DETAILED DESCRIPTION

A broadcast feed transmitted to a viewer may comprise a primary feed (e.g., a video and audio feed from a studio or primary location with an interviewer) and a secondary or remote feed (e.g., a video and audio feed from a remote location with an interviewee). A communication delay or latency associated with transmitting the primary feed from the studio location to the remote location, and transmitting the response from the remote feed back to the studio location, may be received and determined. A segment of the primary feed may be adjusted using a variable delay based on the communication delay. For example, a first segment of the primary feed (e.g., a segment of the interviewer asking a question) may be delayed such that the time period of the first segment is stretched or increased. In some embodiments, a second segment may be adjusted by having the delay removed such that a second segment is not stretched or increased but is instead reduced. For example, once an interviewer has finished asking a question, the delay to the primary feed may be removed such that the time period for the second segment is decreased.

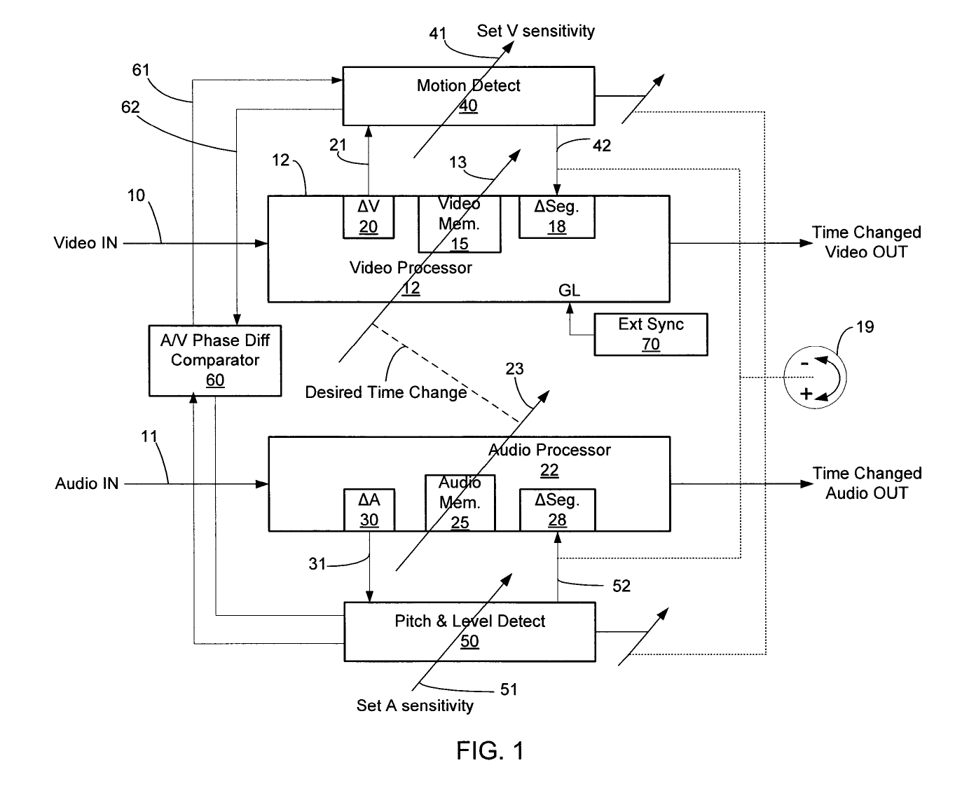

FIG. 1 is a block diagram of a simplified video and audio processing system 5 incorporating the method. As seen in this figure, the video and audio portions of standard program signals are initially separated into an individual video component 10 and audio component 11 using conventional circuitry (not shown). The video portion 10 of the program signal is applied to the input of a video signal processor unit 12, which includes a digital memory 15 for storing the digital video signal. The video signal processor unit 12 generates an output signal 17 that is a time-changed video signal.

Similarly, the audio portion 11 of the program signal is applied to an audio signal processing unit 22, which includes a digital memory 25 for storing the digital audio signal. The audio signal processor unit 22 generates an output signal 27 that is a time-changed audio signal.

The digital video memory 15 is a conventional digital storage unit having a capacity at least equal to the maximum accumulation time expected to be afforded by the system. For example, in a system designed to accumulate 1-4 seconds worth of video, the digital video memory 15 would be configured to have a capacity to hold a certain number of video frames. Similar considerations apply to the digital audio memory 25. However, the total storage capacity of the digital audio memory 25 may be substantially less than that of the digital video memory 15 due to the lower frequencies at which audio is conveyed. In some embodiments, the digital audio memory 25 is configured to have a storage capacity of 1-4 seconds (i.e., the same time storage capacity as that of the digital video memory 15).

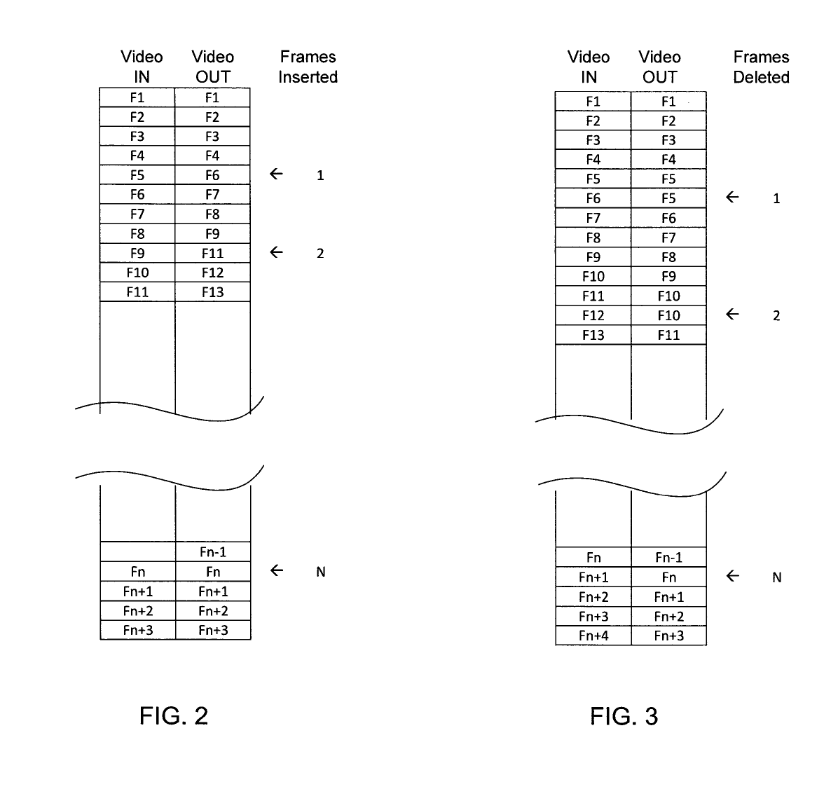

Video processing unit 12 incorporates a delta segment circuit 18 which may be manually overridden by a manual control 19. The purpose of the delta segment circuit 18 is to either delete or insert frames of video from the sequence of frames stored in digital video memory 15 on a programmed basis. Frame deletion is done by simply skipping over a frame in the normal sequence of frames and is described below with reference to FIG. 2. Frame insertion is accomplished by simply repeating a given frame in the frame sequence and is described below with reference to FIG. 3.

In a periodic mode of operation, the frame deletion or insertion rate is set by the manual control 19, which the operator uses to dial in the total number of frames or amount of time to be deleted or added to the original program content during the initial stage of the signal processing. Thus, for example, if the operator wishes to delete ten seconds of time over a one-hour period, that number is entered by means of the manual control 19 into the delta segment circuit 18, and the delta segment circuit periodically deletes every ith frame until a total of 10 seconds worth of frame time has been deleted or saved.

During the frame deletion or insertion processing in a periodic mode, a delta V circuit 20 keeps track of the total time value of the deleted or inserted frames. In one embodiment, the delta V circuit 20 is a counter which receives frame deletion or insertion signals from the delta segment circuit 18 and either increments or decrements the counter in response to each deleted or inserted frame.

The audio processing circuit 22 is provided with a delta segment circuit 28 and delta A circuit 30 for the similar purpose of deleting or adding audio segments and keeping track of the total number or time value of the segments deleted or inserted. The delta segment circuit 28 is controlled by the manual control 19 in tandem with the delta segment circuit 18. However, the actual audio portions which are deleted or repeated by the audio processor unit 22 need not correspond exactly to the same video frames which are deleted or repeated by the video processing unit 12. In fact, the audio portions which are deleted or inserted may be segments of audio signals from different video frames. It is sufficient that any time delay between the video and the audio signal portions subjected to the time variation processing and presented as outputs 17, 27 not exceed +/−3 video frames, with a maximum difference of +/−1 frame being preferred. By observing these constraints, no observable lip sync error is introduced into the original programming material.

The video processing unit 12 may be coupled to and driven by an external sync generator 70, such as a studio sync generator, that provides sync signal GL so that the video processing can be done in synchronous fashion with other video broadcasting or reproduction equipment.

In some embodiments, the video and audio processing system as shown in FIG. 1 may comprise a computer system comprising at least one processor and memory. In some embodiments, a computer-implemented or computer-executable version of the disclosure may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

FIG. 2 is a diagram illustrating a simplified frame deletion process in either the periodic or manual mode in accordance with some embodiments. As schematically represented in this figure, the leftmost column 101 represents the sequence of video frames that are input into the video processing unit 12. The middle column 102 represents the sequence of video frames that are output from the video processing unit 12 after processing is done. The rightmost column 103 indicates the total number of frames deleted.

The process begins by specifying with manual control unit 19 the number of frames to be deleted or the time value of these frames to the delta segment unit 18. Thereafter, in one example, the first four frames (F1-F4) are simply passed through the processing unit 12 essentially unaffected. Frame 5 (F5), however, is deleted and replaced with frame 6 (F6), and frames 7-9 (F7-F9) are output in sequence after frame 6. Similarly, frame 10 (F10) is deleted, and frame 11 (F11) is output after frame 9 (F9). Thus, after five frame times, one frame is deleted; after ten frame times, two frames are deleted, etc., up until the desired total number of frames N (or the time corresponding thereto) are removed. Thereafter, the remaining frames are simply passed through the digital video memory 15 essentially unaffected since the total desired amount of time has already been accumulated.

During the frame deletion process, segments of audio are similarly deleted. However, the audio segments need not correspond exactly to the video frames deleted. Stated differently, portions of audio from one frame may be deleted along with portions of audio from a preceding or succeeding frame; or all of the audio of a given frame may be deleted, as desired. The manner in which the audio segments are actually chosen for deletion will depend upon the frequency characteristics of the audio encountered, and the segments are chosen in order to minimize the introduction of any audible noise signals into the final output signals.

FIG. 3 is a diagram illustrating a simplified frame insertion process in order to expand the total run time of the program material (e.g., a primary feed) in accordance with some embodiments. This process is essentially the converse of the frame deletion process shown in FIG. 2, where the leftmost column 111 represents the sequence of video frames that are input into the video processing unit 12; the middle column 112 represents the sequence of video frames that are output from the video processing unit 12 after processing is done; and the rightmost column 113 indicates the total number of frames inserted. The process proceeds by specifying the total number of frames or the time equivalent to be inserted into the length of the program material using manual control unit 19, followed by processing of the successive frames of video (and corresponding audio) to repeat every ith frame until the total number of frames (i.e., the desired time) have been accumulated.

Thus, in one example, every fifth frame is repeated until the total number of frames (i.e., the desired time) have been accumulated. For example, after five frames, frame F5 is repeated then followed by frames F6-F10; frame F10 is then repeated and followed by frames F11-F15; etc.

The time equations which apply to proper operation of the method to add the variable time delay are discussed below. As noted above, delta segment circuits 18, 28 can be manually overridden by manual control unit 19 to provide operator-controlled frame insertion or frame deletion. In a preferred embodiment, manual control unit 19 includes a rotatable knob with a detent feel. Rotation of the knob in the clockwise direction provides one inserted frame per detent; while rotation of the knob in the counter-clockwise direction results in one frame deletion per detent. Not illustrated in the figure is a display unit, which may be any one of a number of conventional display devices (e.g., an LCD display) which indicates the total number of frames or total time value selected by the manual control unit 19 and, if desired, the running total of delta V and delta A.

Returning to FIG. 1, an “auto mode” of operation is also provided. In this mode of operation, the total number of frames or total amount of time to be deleted or inserted is again specified by manual control unit 19. However, the actual choice of which particular frames are to be deleted or inserted and which particular audio segments are to be deleted or inserted, is automatically controlled by a pair of detector circuits. Control of the video frame deletion/insertion is done by a motion detector circuit 40 which incorporates any one of a number of known algorithms for determining the amount of motion change between adjacent frames, and permits deletion/insertion of a given frame whenever the change in motion between the frames does not exceed a selected threshold value. Such circuits are well known for video compression and coding systems. However, motion detect circuit 40 is constrained to either delete or insert a specified total number of frames over a fixed period of time in accordance with the parameters specified by manual control unit 19. Consequently, motion detect circuit 40 is provided with the accumulated total count from the delta V circuit 20 as signal 21, and an internal timing unit (not illustrated) in order to measure the progress of the frame deletion or insertion processing. If the total number of deleted or accumulated frames runs behind the elapsed real time, for example, due to program content with relatively large amounts of motion over a large sequence of frames, the motion detect threshold is automatically raised by the motion detect circuit 40 in order to permit a relatively larger number of frames to be deleted or inserted so that the system will succeed in deleting or inserting the desired amount of time over the prescribed total program real time period.

Similarly, a pitch and level detect circuit 50 selects which audio portions contain the most effective frequencies and amplitudes capable of being deleted with minimal impairment to the audio content (e.g. by not introducing “pops” or “clicks” into the audio). Pitch and level detect circuit 50 is similarly supplied with the running total from the delta A circuit 30 as signal 31, and is provided with a threshold adjusting circuit to enable the threshold to be raised if the audio deletion processing is running behind the total elapsed time of the real time program.

The sensitivity threshold of detector circuits 40 and 50 may also be functionally coupled to the amount of time change desired, as suggested by the diagonal arrows 13, 23, 41 and 51 overlying elements 12, 22, 40 and 50, respectively. Thus, for a maximum amount of time change, the sensitivity thresholds are raised, while for a minimum amount of time change, the sensitivity thresholds are lowered.

The motion detect circuit 40 and the pitch and level detect circuit 50 are provided with control output lines 42, 52 which are used to control the delta segment circuits 18, 28, respectively, on an on-the-fly basis. Thus, for example, motion detect circuit 40 may determine that three successive frames are to be deleted from the frame sequence. In that case, a control signal is issued on control line 42 to the delta segment circuit 18 to delete the three identified successive frames. Similarly, pitch and level detect circuit 50 will determine those audio segments which are to be deleted from frame portions, and control signals are issued on control line 52 to the delta segment circuit 28.

In order to ensure that the total time delay between the time changed output video signal 17 and the time changed output audio signal 27 does not exceed the preselected maximum frame difference (i.e., +/−0.1 frame time in some embodiments), the accumulated video time and accumulated audio time are coupled from the delta V circuit 20 and delta A circuit 30, respectively, via motion detect circuit 40 and pitch and level detect circuit 50 to an A/V phase difference comparator 60. In the event that the video portions 17 and the audio portions 27 on the output terminals are close to the maximum separation difference, the comparator 60 issues control signals on control lines 61, 62 to the motion detect circuit 40 and pitch and level detect circuit 50, respectively. These control signals are then used by detector circuits 40, 50 to select video frames and audio segments for deletion or insertion which steer the A/V difference in the proper direction.

As will now be apparent, the method is capable of increasing and decreasing passages of time in programming material (e.g., the primary feed) by significant amounts, without impairing the subjective quality of the programming materials as viewed. For example, by deleting one out of every twelve frames, a total of five minutes per hour can be accumulated or “saved” for other purposes. Similarly, by adding an additional frame every six frames in video, ten minutes per hour can be added to the total running time of programming material. In addition, it should be noted that the removal of audio segments at different points in time from the video frames optimizes the quality of the final video/audio output from the system, since it enables separate alteration of the video and audio portions based on the information content and using techniques which are optimal to video signals and audio signals separately. This ensures that the quality of the finally produced programming material is nearly as high as the original material.

While the foregoing provides a full and complete description of some embodiments of a method to increase or decrease passages of time of segments in a primary feed, various modifications, alternate constructions and equivalents may be employed, as desired. For example, while the method has been described with reference to deletion and insertion of frames of video, these principles apply to deletion and insertion of individual fields of information. Therefore, the descriptions and illustrations provided herein should not be construed as limiting the scope of the method.

For a system implementing the described embodiments, the following time equations must hold true:

$$Δ {T}_{v} = {\sum }_{o}^{n} Δ {t}_{v}$$

$$Δ {T}_{A} = {\sum }_{o}^{a \cdot n} Δ {t}_{A}$$

where ΔTᵥ=Total accumulated Video delay (±) time; ΔT_{A}=Total accumulated Audio delay (±) time; Δtᵥ=Time duration of each Video packet (usually one frame); Δt_{A}=Time duration of each Audio packet (about 8 ms for this example); n=Number of Video packets needed to achieve total time change desired; and a=ratio between the time duration of the video and audio packets.

For the system to work, the following equations (1) and (2) must hold to accomplish the desired time change (±) while maintaining lip-sync. Equation (1) holds for exact lip-sync while Equation (2) holds for minimum picture and sound anomalies.

ΔTᵥ=ΔT_{A} or (1)

ΔT_{A}=ΔTᵥ+Δtᵥ (2)

The system can operate in the two different run modes: (i) Manual—where a knob can be turned clockwise or counter clockwise to increase or decrease time in frame increments; and (ii) Auto—where a preset amount of time change (±) will automatically accrue where the audio and video can be locked together (ΔTᵥ=ΔT_{A}) or run independently (ΔT_{A}=ΔTᵥ+Δtᵥ)

The system has the following key features: (i) Time change accrual can be stopped and restarted to coincide with such sacred timed segments as commercials; (ii) Motion, pitch and level change sensitivity can be adjusted to speed up or slow down the rate of time change accrual; (iii) Maximum number of packet changes per second can be set to minimize excessive changes in time in the Auto mode.

The preceding discussion describes a simplified process of eliminating or adding frames to change the over-all length of time of a program signal. Other embodiments may pre-process or post-process the video frames by using frame-to-frame interpolation, motion compensation, or other methods designed to evenly arrange the motion content over the remaining frames, thus reducing any motion artifacts caused by a dropped or repeated frame. Similarly, other embodiments may pre-process or post-process the audio signal to reduce any artifacts caused by dropping or repeating audio segments.

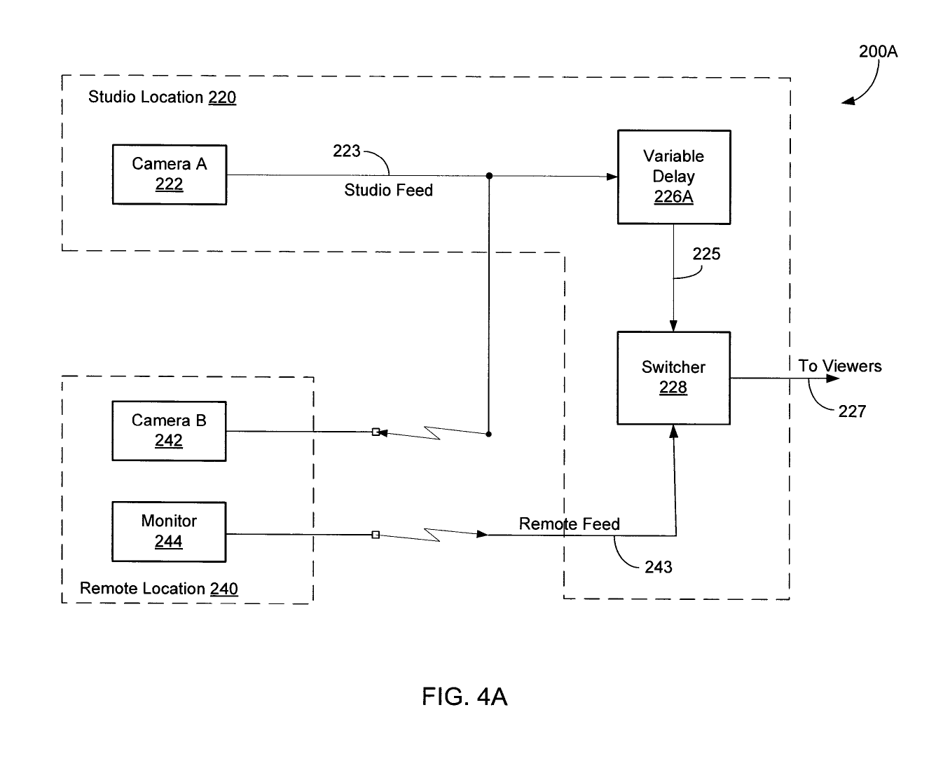

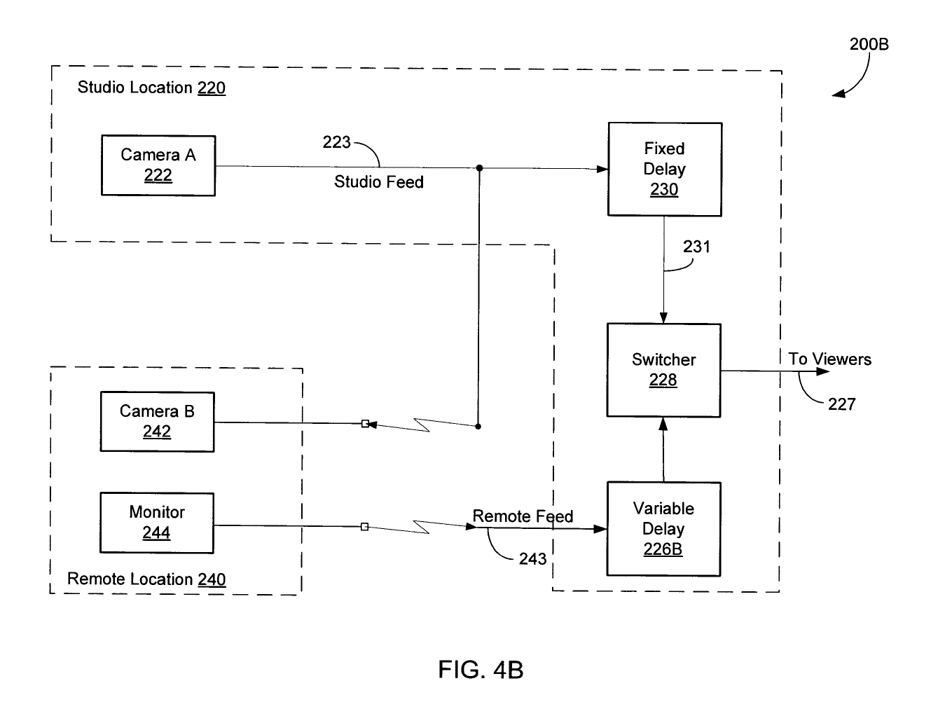

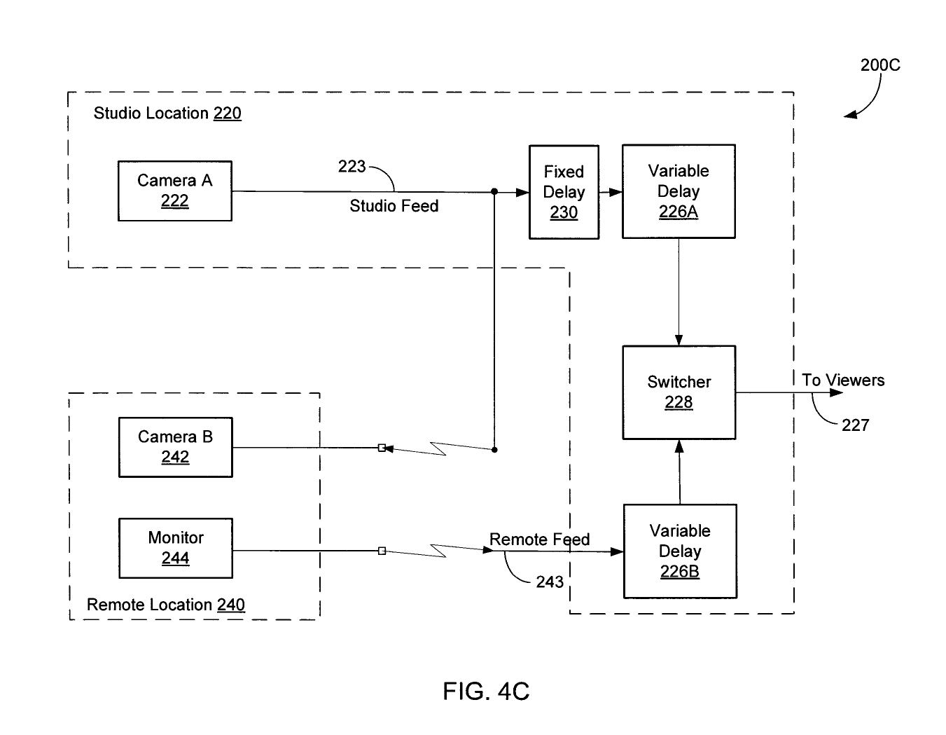

An example program broadcast environment 200A showing a primary location 220 and a remote location 240 is shown in FIG. 4A. The primary location 220 (e.g. studio location) includes at least one camera 222 that generates a primary feed 223. The primary feed 223 is transmitted to the remote location 240, as well as to a variable delay component 226A that may be located at the primary location 220. A modified feed 225 is sent from the variable delay component 226A to a switcher 228, and ultimately, the final program feed 227 is broadcast to viewers from the switcher.

The remote location 240 includes at least one camera 242 that generates the remote feed 243 to switcher 228, and a monitor 244 for receiving and displaying the primary studio feed 223. A communication delay is associated with receiving the primary feed 223 at the remote location 240 and with receiving the remote feed 243 at the switcher.

As shown in FIG. 4A, the variable delay component 226A may be located on the primary feed 223. However, in some embodiments, the variable delay component may be placed on the remote feed, or on both the primary feed and the remote feed. For example, FIG. 4B shows a similar broadcast environment 200B having a fixed delay component 230 on the primary feed 223 and a variable delay component 226B on the remote feed 243. Likewise, FIG. 4C shows a similar broadcast environment 200C having a fixed delay component 230 on the primary feed 223, a first variable delay component 226A on the primary feed 223, and a second variable delay component 226B on the remote feed 243.

Thus, the remote feed may be adjusted (e.g., stretched) instead of or in addition to the primary feed in order to reduce or remove the pause in the broadcast. For example, both the primary feed and remote feed may be adjusted (e.g., by the dynamic variable delay) so that half of the delay (or other proportions) may be removed from each of the primary feed and remote feed. As such, the addition of the variable delay may be the primary feed, the remote feed, or both the primary feed and the remote feed.

In some embodiments, the method described above to increase or decrease a passage of time (e.g., a time period) for segments of a primary feed as described with relation to FIGS. 1-3 may be used to eliminate an awkward pause in a broadcast feed. For example, in some embodiments, the method shortens or eliminates the awkward pause by applying a dynamically adjustable audio/video delay to the primary feed (i.e., an adjustment to the primary feed) before it is sent to the viewer. The primary feed that is sent to the remote location and the feed coming back from the remote location remain unaltered. The dynamically adjustable delay is used to effectively stretch the time period for questions being asked by an interviewer at the primary feed location so that it covers up the pause before the interviewee answers the question. The amount of the delay should be approximately the same as the communication delay. Once the question is finished, the delay in the primary feed is reduced back to zero, ready for the next question. The end result is that the viewer sees and hears the question for a longer period of time followed immediately by the response from the remote feed, thus eliminating the awkward pause.

The dynamically adjustable audio/video delay is used to expand and reduce the duration of the live primary feed. This method dynamically switches between modes seamlessly during the course of a live program. The dynamically adjustable delay begins at zero. When the person begins asking his question, time expansion occurs by slowly increasing the delay until it reaches an amount equal to the communication delay. When the question is finished, time reduction occurs by slowly reducing the delay back to zero. The time periods for expansion and reduction are predefined, and should be the typical period of the question being asked. This method of dynamically increasing and decreasing delay is called “variable delay.”

The method of controlling the variable delay may be done manually, where someone initiates the expansion mode while the question is being asked, and later initiates reduction mode after the question is finished. In addition to manual control, some embodiments may also provide for automatic control. Automatic control may be achieved by monitoring the audio signal of the primary feed. It is assumed that the only audio signal present will be that of the person asking the question. When the audio level of the primary feed exceeds a predefined threshold, audio is detected and triggers the start of the expansion mode. When audio is no longer detected, i.e., the audio level is below the threshold, for a predefined period of time, this will trigger the time reduction mode.

An example apparatus to perform the automatic variable delay mode method can support a high definition serial digital interface (HD-SDI) through use of a series of memory buffers and processors. These processors may provide the analytics and decision skill to drop or add video frames and corresponding audio to achieve the desired run-time. In one example, the automatic variable delay mode provides a detector that may search for a pre-defined stereo pair from 16 channels of audio available in the apparatus. The operator may manually specify the audio threshold that triggers the variable delay mode operation and starts the time expansion on the primary audio/video signal. The primary signal may be automatically expanded by a pre-defined amount set by the operator, followed by auto-reduction to remove the time delay by the same amount from the primary signal. This may keep sequential transitions and scheduled dialogue on clock. The variable delay mode may be disabled at the completion of the interview or dialogue. This may prevent further expansion of the primary signal going into the next broadcast segment.

As such, live audio/video program segments (e.g., segments of a primary feed)) with a remote feed contain a communication delay that is shown as a long pause between speakers. The communication delay is effectively reduced or eliminated by dynamically adding a delay to the primary speaker for the viewers at home. While the remote speaker is responding, the primary feed may be reduced by the same delay time to maintain scheduled run-time of the segment.

Example of the controls used for variable delay mode are listed in Table I below:

TABLE I

| | |
|---|---|
| Delay Time = | [0 to 30 seconds in 1 frame increments] |
| Entry Time = | [0 to 10 minutes in 1 second increments] |
| Exit Time = | [0 to 10 minutes in 1 second increments] |
| Audio Activation | [select from 1 + 2, 3 + 4, 5 + 6, 7 + 8, 9 + 10, |
| Ch Pair = | 11 + 12, 13 + 14, 15 + 16] |
| Audio Activation | [select from −40 dB to +20 dB (full scale) in 1 dB |
| Threshold = | increments] |
| Audio Activation | [select from 0 to 3 seconds in 0.2 second |
| Timeout = | increments] |
| Audio Activation | [select Enable to allow auto activation] |
| Enable/Disabled | |
| GPI-HOLD | [when active, this port prevents audio |
| | detection] |

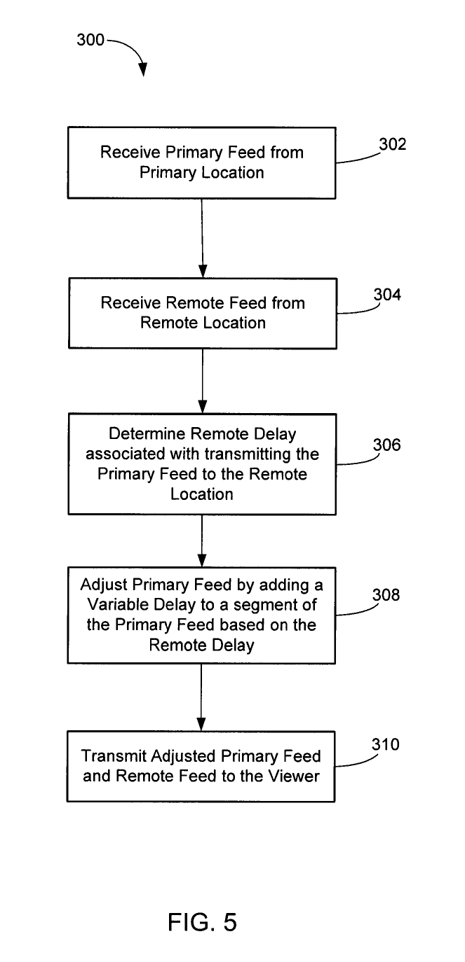

In an embodiment, a method 300 for performing the variable delay mode technique as previously described may involve adding and/or removing a variable delay to segments of a program broadcast feed (e.g., the primary feed) as shown in FIG. 5. In step 302, a primary feed is received from a primary location. In step 304, a remote or secondary feed is received from a remote or secondary location. In step 306, the communications delay associated with transmitting the primary feed to the secondary location is determined. In step 308, the primary feed is adjusted through a variable delay that is based on the communication delay. In step 310, the adjusted primary feed and the remote feed are broadcast to viewers.

In the same or alternative embodiments, the adding of the variable delay to a segment of the primary feed may result in either slowing down the segment such that the video and audio for the segment is seen and heard for a longer period of time. Furthermore, the removing of the variable delay from a segment of the primary feed may result in either speeding up or increasing the segment such that the video and audio for the segment is seen and heard for a shorter period of time. As such, the variable delay may be used to adjust a time period (e.g., increase or decrease the time period) for one or more segments of the primary feed.

In some embodiments, the variable delay mode method may receive a primary feed from a primary location (e.g., a studio location or interviewer) and a remote feed from a remote location (e.g., a field reporter or interviewee). The primary feed may be transmitted to the remote location (e.g., through a satellite link or Internet connection). In some embodiments, a remote location delay may be associated between the primary location and the remote location. For example, the transmission of the primary feed to the remote location may be associated with latency (e.g., the remote location delay).

In some embodiments, the primary feed may further be received by a variable delay component to adjust the primary feed by adding a variable delay to one or more segments of the primary feed. In the same or alternative embodiments, the variable delay may be added to one or more segments of the primary feed based on the remote location delay. In some embodiments, a method to add the variable delay may comprise receiving the primary feed from the primary location and the remote feed from the remote location. The primary feed may comprise a plurality of segments. The method may further determine or receive a remote location communications delay associated with transmitting the primary feed from the primary location to the remote location. A first segment (e.g., an interviewer asking a question) of the primary feed may be adjusted by adding a variable delay to the first segment. The variable delay may adjust the time period of the first segment by extending the time period by an amount of time based on the remote location delay. In some embodiments, after some time (e.g., once an interviewer has finished asking the question), the variable delay may be reduced and/or removed. For example, the variable delay may be reduced for other segments of the primary feed. In some embodiments, the variable delay may be reduced by the amount that was added to the first segment of the primary feed. As such, a second segment of the primary feed may be adjusted by removing or reducing the variable delay that had been added to the primary feed.

In some embodiments, a switcher or switching component may receive an adjusted primary feed (e.g., the primary feed with the variable delay) and the remote feed. The adjusted primary feed and the remote feed may then be transmitted to a viewer.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

1. A method, comprising:
receiving a primary broadcast feed having an inherent communication delay;
receiving a secondary broadcast feed; and
applying a variable delay to a plurality of segments of either the primary broadcast feed or the secondary broadcast feed to effectively align the primary and secondary broadcast feeds by reducing the inherent communication delay.

2. The method of claim 1, the variable delay further comprising dynamically expanding a period of some of the segments of the primary or secondary broadcast feed.

3. The method of claim 1, the variable delay further comprising dynamically reducing a period of some of the segments of the primary or secondary broadcast feed.

4. The method of claim 1, the variable delay further comprising dynamically expanding a period of a first group of the segments of the primary or secondary broadcast feed and dynamically reducing a period of a second group of the segments of the primary or secondary broadcast feed.

5. The method of claim 1, further comprising:
applying the variable delay when an audio signal is detected.

6. The method of claim 1, further comprising:
selecting the variable delay automatically.

7. The method of claim 1, further comprising:
selecting the variable delay manually.

8. A method, comprising:
receiving a first broadcast feed and a second broadcast feed, wherein an inherent communication delay exists between the first and second broadcast feeds; and
deleting or inserting a plurality of video frames from a video portion of either the first broadcast feed or the second broadcast feed thereby reducing the inherent communication delay.

9. The method of claim 8, wherein video frames are deleted by skipping selected video frames.

10. The method of claim 8, wherein video frames are inserted by repeating selected video frames.

11. The method of claim 8, further comprising:
deleting or inserting a plurality of audio segments from an audio portion of either the first broadcast feed or the second broadcast feed.

12. A system, comprising:
a first signal processing circuit configured to receive and process a video portion of a broadcast signal;
a second signal processing circuit configured to receive and process an audio portion of the broadcast signal; and
a first delta segment circuit in the first signal processing circuit configured to delete or insert video frames from the video portion of the broadcast signal.

13. The system of claim 12, wherein the first delta segment automatically deletes or inserts video frames.

14. The system of claim 13, further comprising:
a manual override for deleting or inserting video frames.

15. The system of claim 12, wherein video frames are deleted by skipping selected video frames, and wherein video frames are inserted by repeating selected video frames.

16. The system of claim 12, further comprising:
a first counter configured to count the number of video frames deleted or inserted.

17. The system of claim 12, further comprising:
a second delta segment in the second signal processing circuit configured to delete or insert audio segments from the audio portion of the broadcast signal.

18. The system of claim 17, further comprising:
a second counter configured to count the number of audio segments deleted or inserted

19. The system of claim 12, further comprising:
a first detector circuit coupled to the first signal processing circuit for determining which video frames to delete or insert.

20. The system of claim 12, further comprising:
a second detector circuit coupled to the second signal processing circuit for determining which audio segments to delete or insert.
